(19) United States
(12) Patent Application Publication
(10) Pub. No.: US 2016/0057088 A1
(43) Pub. Date: Feb. 25, 2016

(54) METHOD AND APPARATUS FOR TRANSMITTING INFORMATION

(71) Applicant: NOKIA TECHNOLOGIES OY, Espoo (FI)

(72) Inventors: Alvin Chin, Beijing (CN); Jilei Tian, Beijing (CN)

(21) Appl. No.: 14/781,435

(22) PCT Filed: Mar. 27, 2014
(86) PCT No.: PCT/FI2014/050224

§ 371 Date: Sep. 30, 2015

(30) Foreign Application Priority Data
Apr. 1, 2013 (CN) 201310117571.9

(51) Int. Cl. H04L 12/58; H04L 29/08

(52) U.S. Cl. CPC H04L 51/14; H04L 67/10; H04L 51/24

(57) ABSTRACT

Embodiments of the present invention provide a method and apparatus for transmitting information. In one embodiment of the present invention, there is provided a method for transmitting information, comprising: creating an activity in response to having received inputted information from a user U; looking up a first number of users matching the activity in contact information of the user U; adding the first number of users into a candidate list; transmitting a notification of the activity to users in the candidate list; wherein the contact information comprises at least one address book through which the user U communicates with a plurality of other users via at least one communication channel. In other embodiments of the present invention, there is further provided apparatuses for transmitting information.

### FIELD

Embodiments of the present invention relate to data transmission, and more specifically, to a method and apparatus for transmitting information among communication terminals.

### BACKGROUND

With the development of hardware and software techniques of communication terminals, the computing power of communication terminals gets increasingly strong, and with the constant advance of mobile communication techniques, bandwidths supported by communication terminals also become growingly wide. The technological progress provides underlying support for extending functions of communication terminals.

Nowadays, some communication terminals can support other communication channels than voice communication, such as short message service, multimedia message service, email service, instant message service, etc. These services provide conveniences for enhancing communication among users. For example, when a user wants to communicate with other users (e.g., notify users of a conference), he/she may select communication channels supported by communication terminals.

Although some communication tools can support mass texting (e.g., short message service, etc.), the user has to manually select contacts from address books and add them into a mass list before sending. In addition, the user's contacts might be distributed in address books of a plurality of communication tools, at which point the user has to log into these communication tools one by one and select potential targets from corresponding address books before sending a notification. Further, it takes a large amount of duplicated operations to collect other users' feedback information via a plurality of communication channels and record whether each user will take part in the conference.

Suppose when the user (such as the conference organizer) needs to send the notification to dozens or even hundreds of persons via a plurality of communication channels, the workload can be well imagined. In particular, when there exist a plurality of communication channels for contacting certain users, how to organize and coordinate these communication channels so as to provide more convenient communication functions has aroused concerns among software and service providers.

### SUMMARY

Therefore, it is desired to develop a technical solution that can support a user to transmit information to other potential targets more simply and conveniently, and it is desired the technical solution can automatically recommend potential target contacts to the user (e.g., organizer) and can automatically transmit information to each contact via the most efficient communication channel, thereby reducing the user's manual operations as much as possible. Further, it is desired the technical solution can propagate a notification among the user's friends (or friends of friends) in the most efficient way, thereby finding appropriate receivers. On the other hand, it is further desired the technical solution can automatically collect feedback from potential targets and notify the user issuing the notification.

According to one aspect of the present invention, there is provided a method for transmitting information, comprising: creating an activity in response to having received inputted information from a user U; looking up a first number of users matching the activity in contact information of the user U; adding the first number of users into a candidate list; transmitting a notification of the activity to users in the candidate list; wherein the contact information comprises at least one address book through which the user U communicates with a plurality of other users via at least one communication channel.

According to one aspect of the present invention, there is provided an apparatus for transmitting information, comprising: a creating module configured to create an activity in response to having received inputted information from a user U; a lookup module configured to look up a first number of users matching the activity in contact information of the user U; an adding module configured to add the first number of users into a candidate list; and a transmitting module configured to transmit a notification of the activity to users in the candidate list; wherein the contact information comprises at least one address book through which the user U communicates with a plurality of other users via at least one communication channel.

According to one aspect of the present invention, there is provided an apparatus for transmitting information, comprising: at least one processor and at least one memory comprising computer program code, wherein the at least one memory and the computer program code are configured to use the at least one processor to cause the apparatus to: create an activity in response to having received inputted information from a user U; look up a first number of users matching the activity in contact information of the user U; add the first number of users into a candidate list; and transmit a notification of the activity to users in the candidate list; wherein the contact information comprises at least one address book through which the user U communicates with a plurality of other users via at least one communication channel.

According to one aspect of the present invention, there is provided a computer readable storage medium storing program instructions, the program instructions causing at least one processor to: create an activity in response to having received inputted information from a user U; look up a first number of users matching the activity in contact information of the user U; add the first number of users into a candidate list; and transmit a notification of the activity to users in the candidate list; wherein the contact information comprises at least one address book through which the user U communicates with a plurality of other users via at least one communication channel.

By means of the technical solutions described by the embodiments of the present invention, it is possible to greatly reduce a user's manual operations and support the user to achieve more efficient communication via a communication terminal.

### BRIEF DESCRIPTION OF THE SEVERAL VIEWS OF THE DRAWINGS

Through the more detailed description in the accompanying drawings, the above and other objects, features and advantages of the embodiments of the present invention will become more apparent. Several embodiments of the present invention are illustrated schematically and are not intended to limit the present invention. In the drawings:

FIG. 1 schematically illustrates a block diagram of an exemplary computer system which is applicable to implement the embodiments of the present invention;

FIG. 2 schematically illustrates an architecture diagram of a method for transmitting information to target users according to one solution;

FIG. 3 schematically illustrates an architecture diagram of a technical solution for transmitting information according to one embodiment of the present invention;

FIG. 4 schematically illustrates a flowchart of a method for transmitting information according to one embodiment of the present invention;

FIG. 5 schematically illustrates a schematic view of transmitting information in a plurality of hierarchies according to one embodiment of the present invention;

FIG. 6 schematically illustrates a topological graph constructed based on a current user and users in a participant list according to one embodiment of the present invention;

FIG. 7 schematically illustrates a schematic view after adding a new user into the topological graph as shown in FIG. 6 according to one embodiment of the present invention;

FIG. 8 schematically illustrates a schematic view of optional steps of a method according to one embodiment of the present invention; and

FIG. 9 schematically illustrates a schematic view of an apparatus for transmitting information according to one embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or one embodiment combining software and hardware aspects that may all generally be referred to herein as a “circuit,” “module” or “system.” Furthermore, in some embodiments, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated data signal may take any of a variety of forms, including, but not limited to, an electro-magnetic signal, optical signal, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instruction means which implements the function/act specified in the flowchart and/or block diagram block or blocks.

The computer program instructions may also be loaded onto a computer, other programmable data processing apparatus, or other devices to cause a series of operational steps to be performed on the computer, other programmable data processing apparatus or other devices to produce a computer implemented process such that the instructions which execute on the computer or other programmable apparatus provide processes for implementing the functions/acts specified in the flowchart and/or block diagram block or blocks.

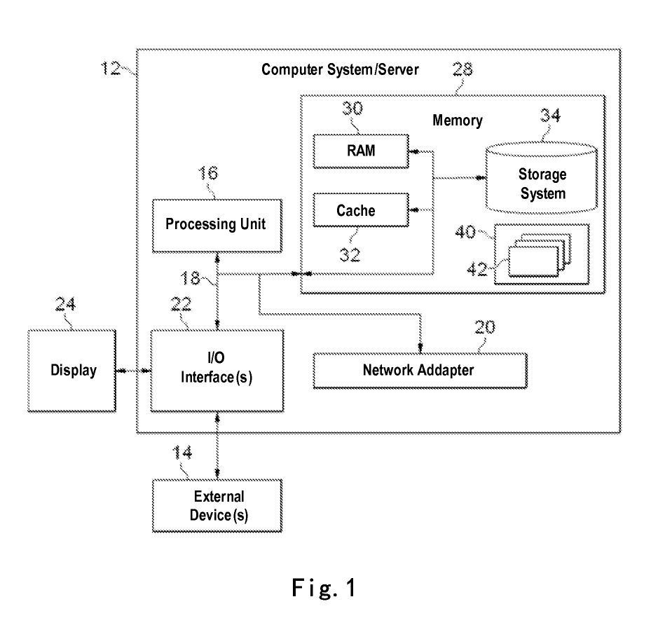

It is appreciated that embodiments of the present application may be implemented in various data processing devices with abilities of computing, data storage and network communication. For example, embodiments may be implemented a server in the communication network, or may be implemented at a communication terminal with acceptable abilities of computing, data storage and network communication. Details of a data processing device which is applicable to implement the present invention are presented below by taking the computer system/server illustrated in FIG. 1 as an example.

Referring now to FIG. 1, in which a block diagram of an exemplary computer system/server 12 which is applicable to implement the embodiments of the present invention is illustrated. Computer system/server 12 illustrated in FIG. 1 is only illustrative and is not intended to suggest any limitation as to the scope of use or functionality of embodiments of the invention described herein.

As illustrated in FIG. 1, computer system/server 12 is illustrated in the form of a general-purpose computing device. The components of computer system/server 12 may include, but are not limited to, one or more processors or processing units 16, a system memory 28, and a bus 18 that couples various system components including the system memory 28 and processing units 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not illustrated in FIG. 1 and typically called a “hard drive”). Although not illustrated in FIG. 1, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. As will be further depicted and described below, memory 28 may include at least one program product having a set (e.g., at least one) of program modules that are configured to carry out the functions of embodiments of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the present invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not illustrated, other hardware and/or software components could be used in conjunction with computer system/server 12. Examples, include, but are not limited to: microcode, device drivers, redundant processing units, external disk drive arrays, RAID systems, tape drives, and data archival storage systems, etc.

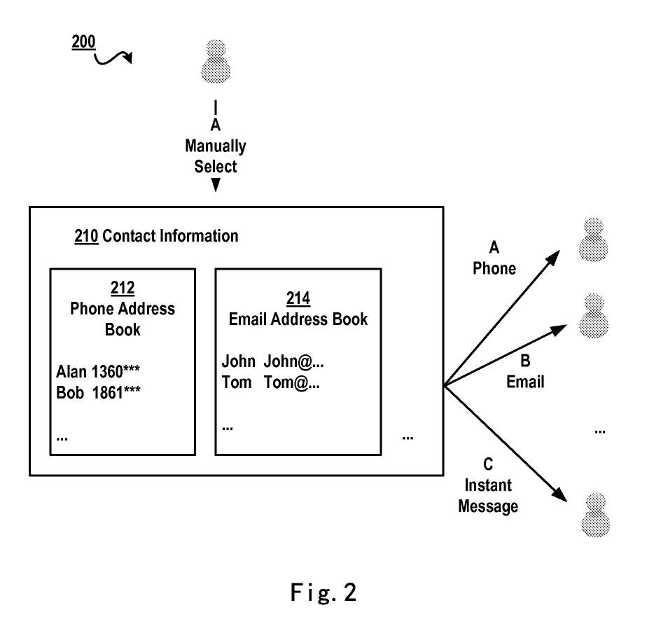

FIG. 2 schematically shows an architecture diagram 200 of a method for transmitting information to target users according to one solution. According to the prior art, a user has to manually log into a plurality of communication tools installed on one or more computer devices (such as a mobile communication terminal, a computer, etc.), select different contacts from contact information 210 (e.g., including a phone address book 212 on the mobile communication terminal and an email address book on the computer) and subsequently transmit information to respective users manually via a plurality of communication channels as shown by arrows A to C.

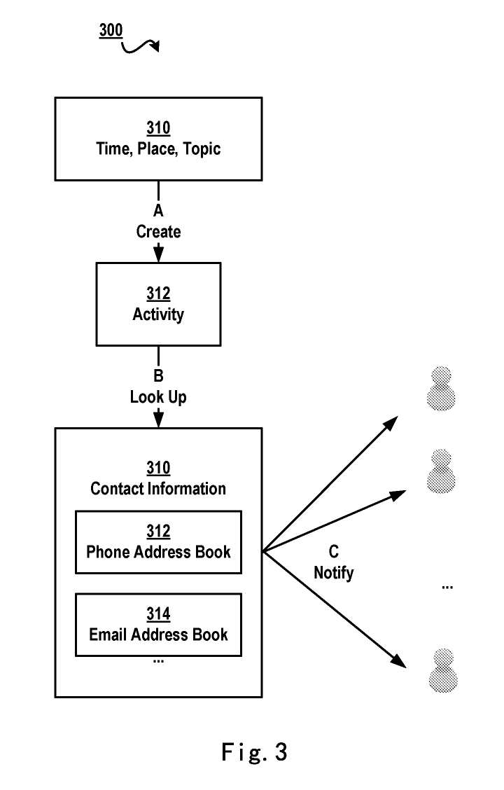

To reduce the complexity of manual labor in this example, the embodiments of the present invention can support such a technical solution as transmitting (e.g., via a plurality of communication channels) information to multiple users through a user's operations on single communication means. FIG. 3 schematically shows an architecture diagram 300 of a technical solution for transmitting information according to one embodiment of the present invention. For example, time, place and topic 310 specified by the user (e.g., organizer) are received and an activity 312 is created (as shown by arrow A) based on the information.

Subsequently, contact methods of potential targets are looked up in contact information 310, so as to transmit a message (as shown by arrow C) to respective users via appropriate communication channels. In this embodiment, contact information 310 may comprise a plurality of address books (e.g., a phone address book 312 and an email address book 314) via which the user U communicates with a plurality of other users via different communication channels (e.g., phone, email, etc.).

In one embodiment of the present invention, there is provided a method for transmitting information, comprising: creating an activity in response to having received inputted information from a user U; looking up a first number of users matching the activity in contact information of the user U; adding the first number of users into a candidate list; transmitting a notification of the activity to users in the candidate list; wherein the contact information comprises at least one address book through which the user U communicates with a plurality of other users via at least one communication channel.

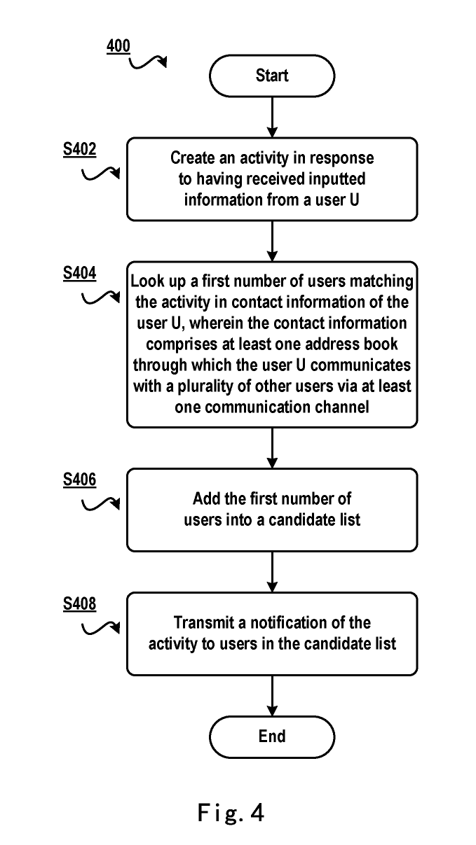

FIG. 4 schematically shows a flowchart 400 of a method for transmitting information according to one embodiment of the present invention. In step S402, an activity is created in response to having received inputted information from a user U. For example, the user may be prompted at the mobile terminal to input the activity's time, place and topic, or other information such as rated number of participants. Where the user's inputted information has been collected, the method of the present invention can be automatically accomplished without manual intervention.

In step S404, a first number of users matching the activity are looked up in contact information of the user U. Note the contact information here comprises at least one address book through which the user U communicates with a plurality of other users via at least one communication channel. In this manner, the user no longer has to log into a plurality of communication tools on one or more communication terminals but can access address books associated with these communication tools.

Users matching the activity may be looked up based on various approaches. For example, users in address books whose personal hobbies indicated in user profile coincide with the activity topic may act as matching users; users who used to communicate with the user U frequently may act as matching users; or a lookup may be conducted based on other criterion.

In step S406, the first number of users are added to a candidate list. Users found in step S404 act as potential targets and are added to a candidate list. The purpose of setting the candidate list is to maintain potential targets found in a looking up step like step S404 and other subsequent looking up step. Next, in step S408 a notification of the activity is transmitted to users in the candidate list. In this embodiment, the notification may be transmitted via the plurality of communication channels involved in the contact information.

In one embodiment of the present invention, the transmitting a notification of the activity to users in the candidate list comprises: obtaining a communication channel corresponding to each user in the candidate list; and transmitting the notification to each user in the candidate list via the corresponding communication channel. Regarding a certain user Alan in the candidate list, for example, based on communication history between U and Alan, a communication channel (e.g., email) that is most frequently used between them may be determined and the notification be transmitted using the communication channel. For example, Alan may view the notification at his own mobile terminal.

The number of users in a contact list of an organizer may be limited. If information is transmitted depending on the organizer's social relations only, then the amount and scope of potential receivers might be limited. In particular, when it is desired to send the notification to as many potential targets as possible, the efficiency of this embodiment is yet to be improved.

In one embodiment of the present invention, the following is further included: in at least one round, looking up a second number of users matching the activity in contact information of a user C in the candidate list; adding the second number of users into the candidate list; and transmitting the notification to the second number of users.

In this embodiment, a user in the candidate list is further allowed to forward the notification received by he/she. For example, the forwarding may be conducted in response to having received a forwarding command from the user C, or may be conducted directly in default.

In this manner, with respect to the first round of transmission conducted based on the contact information of the user U, the user C is the receiver; while in the forwarding conducted based on the contact information of the user C, the user C turns into the sender. During the forwarding, the role of the user C is similar to that of the user U shown in FIG. 4, and the user C can conduct forwarding in a similar way.

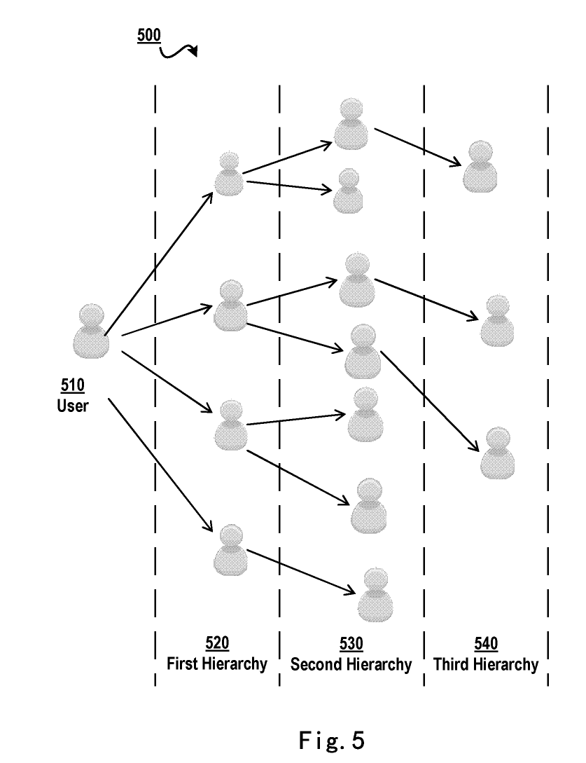

FIG. 5 schematically shows a schematic view 500 of transmitting information in a plurality of hierarchies according to one embodiment of the present invention. As shown in FIG. 5, a user 510 may transmit a notification to a plurality of users (as shown at a first hierarchy 520) according to the method as shown in FIG. 4. Next, the users at first hierarchy 520 may forward the notification to other users (as shown at a second hierarchy 530) based on their own contact information, and the users at second hierarchy 530 may forward the notification to users at a third hierarchy 540, and so on and so forth.

In this manner, the notification may be transmitted to a plurality of potential targets directly or indirectly; moreover, the notification may be forwarded based on associations in address books of various communication tools, and it can further be ensured that users receiving the notification have kind of association among them (for example, know each other in the real world or have been friends via a certain communication channel, such as friends in a social network, etc.).

One advantage of allowing a user in the candidate list to conduct forwarding lies in that information can be transmitted to potential targets more efficiently. In the prior art, the organizer can only maintain his/her own contact information, but cannot access or improbably accesses contact information of other users, and can only transmit the notification to a limited number of users. In the embodiments of the present invention, however, by using contact information of users in the candidate list, not only the notification is directly sent to the organizer's “friends,” but also the notification is indirectly sent to “friends” of the “friends.”

In other words, the present invention can allow the organizer to “forward” the notification at multiple hierarchies thereby achieving more efficient transmission, without a need to maintain a long contact list. In addition, the “forwarding” operation may further invite users with whom the organizer or other invitees are unacquainted to take part in the activity, thereby promoting invitees to extend their friend circle. For example, where the activity is a technical seminar, technicians may further be promoted to share research and development experience.

In one embodiment of the present invention, the looking up a first number of users matching the activity in contact information of the user U comprises: calculating closeness between the user U and a user among the plurality of other users; and selecting a first number of users with the highest closeness from the plurality of other users.

When looking up matching users, it may be considered that the organizer prefers to forward the notification to users having a close relationship with himself/herself; when these users confirm they will participate in the activity, the organizer can attend the activity with these “close friends.” Therefore, the closeness between the organizer and other user may be used as a criterion for matching.

Specifically, whether the closeness is high or low may be measured based on a comparison of values. For example, it may be considered that the more frequent the communication between two users, the higher the closeness between them. Further, difference among different communication channels may be considered; for example, it is considered that the closeness of voice phone communication is higher than the closeness of instant message service, etc.

Based on the above principle, in one embodiment of the present invention, the calculating closeness between the user U and a user among the plurality of other users comprises: with respect to a user Uᵢ among the plurality of other users, obtaining a weight Wⱼ of each communication channel Cⱼ in the at least one communication channel; obtaining frequency Rⱼⁱ that the user U communicates with the user Uᵢ via the communication channel Cⱼ; and calculating closeness CRᵢ=ΣWⱼ·Rⱼⁱ between the user U and the user Uᵢ.

In this embodiment, a weight may be set for each communication channel. Suppose there exist M communication channels, then Σⱼ₌₁^{M}Wⱼ=1 may be defined. For example, Wₚₕₒₙₑ=0.5, Wₑₘₐᵢₗ=0.1, W_{instant message}=0.1, W_{short message}=0.1, W_{multimedia message}=0.1, W_{online social network}=0.1, etc., wherein Wₚₕₒₙₑ+Wₑₘₐᵢₗ+W_{instant message}+W_{short message}+W_{multimedia message}+W_{online social network}=1. The product Wⱼ·Rⱼⁱ of frequency R^{j}ᵢ that two users communicate via the communication channel Cⱼ times the communication channel's weight Wⱼ may be calculated so as to measure the closeness between the two users in the communication channel Cⱼ respect. Finally, a sum of the closeness of all communication channels is calculated as the closeness between the two users. By calculating the sum of the organizer's closeness with all other users, these other users may be ranked. Further, users of higher ranks (e.g., top 10 users) may be selected to be added to the candidate list. Where the activity's participant quota is specified as X, for example, it may be set that └X/2┘ users are selected as the first hierarchy of users (where └ ┘ is a floor function).

In one embodiment of the present invention, the frequency Rⱼⁱ is calculated based on the ratio of communications between the user U and the user Uᵢ via the communication channel Cⱼ to total communications between the user U and the user Uᵢ. Description is presented below to how to calculate closeness between two users by way of example. For example, communications between the user U and the user Uᵢ by phone amount to 10 times, communications by email amount to 80 times, communications by instant message amount to 10 times, and then

Frequency of communication by phone

$${R}_{phone}^{i} = \frac{10}{10 + 80 + 10} = 0.1 ;$$

Frequency of communication by email

$${R}_{email}^{i} = \frac{80}{10 + 80 + 10} = 0.8 ;$$

Frequency of communication by instant message

$${R}_{instant message}^{i} = \frac{10}{10 + 80 + 10} = 0.1 .$$

Closeness between the user U and the user Uᵢ:

CRᵢ=ΣWⱼ·Rⱼⁱ=0.5*0.1+0.1*0.8+0.1*0.1=0.14

Based on the method described above, the ranking of closeness between the organizer and other users can be obtained, and subsequently a plurality of users with higher closeness can be selected.

In one embodiment of the present invention, not only information is transmitted to potential targets, but also feedback indicating whether to participate in the notified activity is received from these potential targets. Specifically, in one embodiment of the present invention, there is further comprised: receiving feedback from users in the candidate list, types of the feedback at least comprising “participating;” in response to the type of feedback from a user A in the candidate list being “participating,” adding the user A into a participant list; and presenting the participant list to the user U.

The feedback may comprise, for example, “participating,” “not participating,” “pending” and other types, or may further comprise additional information of the number of participants (e.g., a notified user may verbally invite other person). At this point, users in the participant list are users who are confirmed to participate in the activity. For example, statistics may be made on the number of persons in the participant list, and when the number of persons is less than the participant quota, other user is allowed to participate. In addition, before adding a new user into the participant list, it may further be judged whether this user exists in the participant list.

In one embodiment of the present invention, before adding the user U into a participant list, there is further comprised: constructing a user set based on the user U, the user A and each user in the participant list, the user set consisting of N users; and adding the user A into the participant list in response to any of: a variance of association relationship between each user and remaining users in the user set is minimal, and a sum of connectivity between each user and remaining users in the user set is maximal.

Specifically, rules to which participants should conform may be set. For example, to ensure each user participating in the activity knows a certain number of other users, it may be provided that a difference in the number of other users whom each user knows should not be too large; in addition, to ensure there is no isolated group among participating users (i.e., users in this group know each other but do not/almost do not know other user outside the group), it may further be specified that users resulting in an isolated group should not be added to the participant list, etc. In the context of the present invention, a topological graph may be built based on users in the participant list (e.g., with users being nodes and with closeness between users being edges), and which user/users are selected based on the principle of graph theory.

In one embodiment of the present invention, the variance described above may be calculated in a manner below: calculating closeness c_{r,s} between any two users Uᵣ and Uₛ in the user set, wherein 1≦r,s≦N; calculating an active index SIᵣ=Σₛ₌₁^{N}c_{r,s} of each user Uᵣ in the user set; and the variance

$$VAR ( SI ) = \frac{{\sum }_{r = 1}^{N} {[ {SI}_{r} - MEAN ( SI ) ]}^{2}}{N} ,$$

wherein

$$MEAN ( SI ) = \frac{{\sum }_{r = 1}^{N} {SI}_{r}}{N} .$$

For example, closeness c_{r,s} between any two users Uᵣ and Uₛ may be calculated in the above manner. In the above equation, the active index may represent overall closeness between a certain user and remaining users; the higher the active index, the larger the possibility that the certain user knows others in the participant list. When it is desired to add a new user into the participant list, the variance may be calculated with respect to each to-be-added user, and then a user minimizing the variance is selected.

Noticeably, the connectivity here may be direct connectivity between two users or indirect connectivity formed via other user. For example, direct connectivity between the two users Uᵣ and Uₛ may be calculated using the closeness calculation described above. When there is no direct relation between Uᵣ and Uₛ but there is a direct relation between users Uᵣ, Uₖ and users Uₖ, Uₛ, indirect connectivity CRᵣₛ between Uᵣ and Uₛ may be calculated based on closeness CRᵣₖ between Ur and Uₖ and closeness between Uₖ and Uₛ. For example, CRᵣₛ=a*CRᵣₖ+b*CRₖₛ, wherein a, b may be attenuation coefficient between 0 and 1.

In one embodiment of the present invention, the connectivity index may be calculated in a manner below: calculating connectivity ci_{r,s} between any two users Uᵣ and Uₛ in the user set, wherein 1≦r,s≦N; and the connectivity index

$$CI = \frac{{\sum }_{r = 1}^{N} {\sum }_{s = 1}^{N} {ci}_{r , s}}{N} .$$

The larger a value of the connectivity index, the higher the possibility that users in the participant list know each other. By selecting a user who can maximize the connectivity index, the occurrence of an “isolated group” among participating users may be avoided to a given extent.

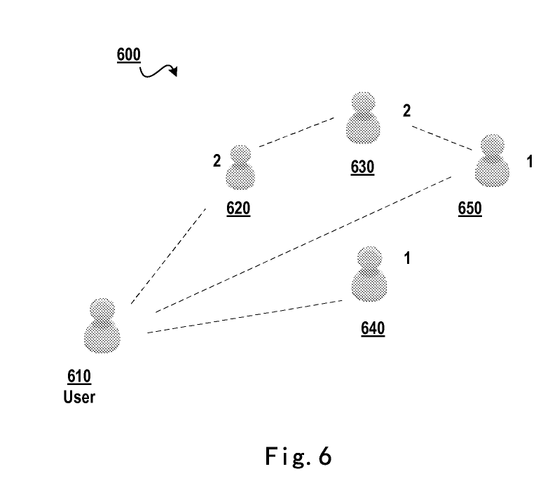

FIG. 6 schematically shows a topological graph 600 constructed based on a current user and users in the participant list according to one embodiment of the present invention. As shown in this figure, a user 610 is the organizer, while other users 620, 630, 640 and 650 are all users in the participant list. Dashed lines in the figure can indicate whether users know each other. For example, user 640 only knows user 610 but do not know other users. For another example, dashed lines in the figure can further indicate an association relationship between two users, e.g., whether the association relationship between two users is strong or weak may be represented by the above closeness.

Numerics above these users represent whether the user has entourage. For example, the numeric above user 620 is 2, representing user 620 and 1 entourage participate in the activity; the numeric above user 640 is 1, representing only user 640 participates. At this point, a total of 7 persons participate in the activity. Suppose the activity's participant quota is 8, then 1 more user should be selected. User 640 is rather isolated (only knows user 610), so a new user may be invited based on the principle of maximizing the connectivity index.

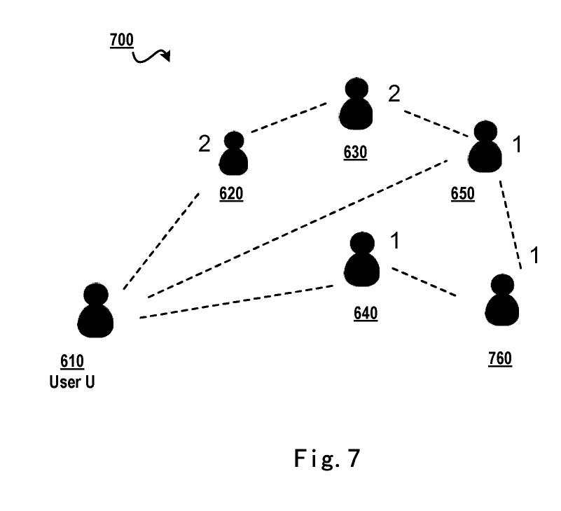

FIG. 7 schematically shows a schematic view 700 after adding a new user 760 into the topological graph 600 as shown in FIG. 6 according to one embodiment of the present invention. As seen from this topological graph, the addition of user 760 increases the overall connectivity index and weakens the isolation of user 640 as shown in FIG. 6.

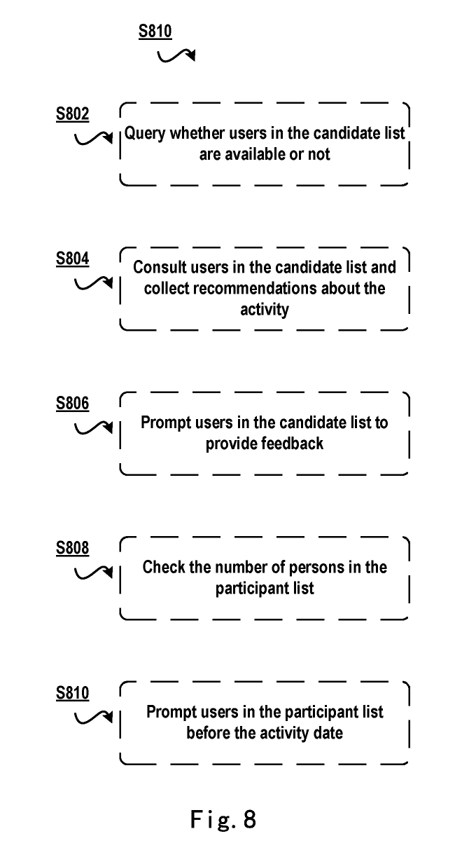

FIG. 8 schematically shows a schematic view 800 of optional steps of a method according to one embodiment of the present invention.

In one embodiment of the present invention, a query operation as shown in step S802 may be executed. For example, users may maintain the calendar in a certain network application so as to record their everyday activities. In this embodiment, the calendar of each user in the candidate list may be checked, so as to query whether the user is available on/at the date/time when the activity takes place. When it is found that the user has arranged other activities, then the notification is not transmitted to this user. Or the notification is still transmitted to the user so as to be forwarded by the user via his/her contact information.

In one embodiment of the present invention, a consultation activity as shown in step S804 may be executed. For example, users in the candidate list are consulted about recommendations with respect to the activity's time, place and so on, and users' recommendations are followed and then the activity information is modified.

In one embodiment, a prompt step as shown in step S806 may be executed. For example, if a notified user returns no feedback or only returns “pending” to the organizer after a certain time period (e.g., 1 day or other time period), then the user may be prompted to give a precise reply as soon as possible.

In one embodiment of the present invention, a check step as shown in step S808 may be executed. For example, it may be checked whether the number of persons in the participant list has reached the participant quota or not; if yes, then the information transmission/forwarding may stop.

In one embodiment of the present invention, a prompt step as shown in step S810 may be executed. For example, it is possible to prompt, one day before the activity, users in the participant list to attend the activity on time.

It should be noted that although steps S802 to S810 are shown in order in FIG. 8, these steps are not necessarily executed in the order as shown; instead, these steps may be executed in parallel, in series, out of order, or only one part of these steps are executed.

Noticeably, the “information” mentioned in the context of the present invention is not limited to the conference notification, but may include, without limitation, invitation information, a questionnaire and other information.

In one embodiment of the present invention, the adding the first number of users into a candidate list further comprises: in response to a select command from the user U, adding at least one part of the first number of users into the candidate list. In this embodiment, the organizer may manually add or delete potential target users.

In one embodiment of the present invention, there is further comprised: in response to the contact information comprising a plurality of address books, obtaining a mapping relationship between one of the plurality of other users and contacts in the plurality of address books based on a cross link algorithm.

It should be noted that a circumstance as below might arise: when using different communication applications, one identical user might be registered using different IDs. For example, concerning a user Alan, in a social network this user might be registered with an ID “HelloWord;” while using a chat tool the user might be registered with his/her phone number “136***.” At this point, it is further necessary to judge the user's mapping relationship among contacts in different address books.

In the context of the present invention, a cross link algorithm may be used for implementation. The cross link algorithm may comprise various respects of contents. For example, the implementation may be achieved by analyzing profile information in different address books. Specifically, a user's real name, birthday, ID number, phone number and other personal information may be analyzed and compared; or authors of issued papers and academic conferences the user once attended may be analyzed and compared, which is not detailed here.

In one embodiment of the present invention, the communication channels comprise at least one of: phone, email, instant message, short message service, multimedia message service, online social network, event history, and chat log.

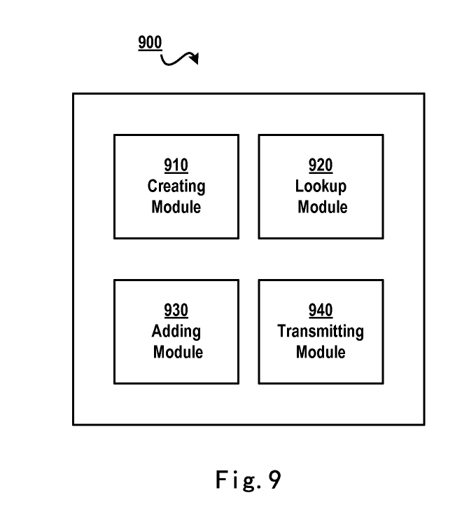

FIG. 9 schematically shows a schematic view 900 of an apparatus for transmitting information according to one embodiment of the present invention. Specifically, FIG. 9 shows an apparatus for transmitting information, comprising: a creating module 910 configured to create an activity in response to having received inputted information from a user U; a lookup module 920 configured to look up a first number of users matching the activity in contact information of the user U; an adding module 930 configured to add the first number of users into a candidate list; and a transmitting module 940 configured to transmit a notification of the activity to users in the candidate list; wherein the contact information comprises at least one address book through which the user U communicates with a plurality of other users via at least one communication channel.

In one embodiment of the present invention, there is further comprised: a second lookup module configured to, in at least one round, look up a second number of users matching the activity in contact information of a user C in the candidate list; a second adding module configured to add the second number of users into the candidate list; and a second transmitting module configured to transmit the notification to the second number of users.

In one embodiment of the present invention, lookup module 920 comprises: a closeness calculating module configured to calculate closeness between the user U and a user among the plurality of other users; and a selecting module configured to select the first number of users with the highest closeness from the plurality of other users.

In one embodiment of the present invention, the closeness calculating module comprises: a weight obtaining module configured to, with respect to a user among the plurality of other users, obtain a weight Wⱼ of each communication channel C, in the at least one communication channel; a frequency obtaining module configured to obtain frequency Rⱼⁱ that the user U communicates with the user Uᵢ via the communication channel Cⱼ; and a calculating module configured to calculate closeness CRᵢ=ΣWⱼ·Rⱼⁱ between the user U and the user Uᵢ.

In one embodiment of the present invention, the frequency Rⱼⁱ is calculated based on the ratio of communications between the user U and the user Uᵢ via the communication channel Cⱼ to total communications between the user U and the user Uᵢ.

In one embodiment of the present invention, there is further comprised: a receiving module configured to receive feedback from users in the candidate list, types of the feedback at least comprising “participating;” a participant adding module configured to, in response to the type of feedback from a user A in the candidate list being “participating,” add the user A into a participant list; and a presenting module configured to present the participant list to the user U.

In one embodiment of the present invention, there is further comprised: a constructing module configured to construct a user set based on the user U, the user A and each user in the participant list, the user set consisting of N users; and a filtering module configured to add the user A into the participant list in response to any of: a variance of association relationship between each user and remaining users in the user set is minimal, and a sum of connectivity between each user and remaining users in the user set is maximal.

In one embodiment of the present invention, the variance is calculated in a manner below: calculating closeness c_{r,s} between any two users Uᵣ and Uₛ in the user set, wherein 1≦r,s≦N; calculating an active index SIᵣ≦Σₛ₌₁^{N}c_{r,s} of each user Uᵣ in the user set; and the variance

$$VAR ( SI ) = \frac{{\sum }_{r = 1}^{N} {[ {SI}_{r} - MEAN ( SI ) ]}^{2}}{N} ,$$

wherein

$$MEAN ( SI ) = \frac{{\sum }_{r = 1}^{N} {SI}_{r}}{N} .$$

In one embodiment of the present invention, the connectivity index may be calculated in a manner below: calculating connectivity ci_{r,s} between any two users Uᵣ and Uₛ in the user set, wherein 1≦r,s≦N; and the connectivity index

$$CI = \frac{{\sum }_{r = 1}^{N} {\sum }_{s = 1}^{N} {ci}_{r , s}}{N} .$$

In one embodiment of the present invention, there is further comprised: an obtaining module configured to, in response to the contact information comprising a plurality of address books, obtain a mapping relationship between one of the plurality of other users and contacts in the plurality of address books based on a cross link algorithm.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks illustrated in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-31. (canceled)

32. A method for transmitting information, comprising:
creating an activity in response to having received inputted information from a first user;
looking up a first number of users matching the activity in contact information of the first user;
adding the first number of users into a candidate list; and
transmitting a notification of the activity to users in the candidate list;
wherein the contact information comprises at least one address book through which the first user communicates with a plurality of other users via at least one communication channel.

33. The method of claim 32, further comprising: in at least one round,
looking up a second number of users matching the activity in contact information of a second user in the candidate list;
adding the second number of users into the candidate list; and
transmitting the notification to the second number of users.

34. The method of claim 32, wherein the looking up a first number of users matching the activity in contact information of the first user comprises:
calculating closeness between the first user and a user among the plurality of other users; and
selecting the first number of users with the highest closeness from the plurality of other users.

35. The method of claim 32, further comprising:
receiving feedback from users in the candidate list, types of the feedback at least comprising “participating;”
in response to the type of feedback from a third user in the candidate list being “participating,” adding the third user into a participant list; and
presenting the participant list to the first user.

36. The method of claim 35, wherein before adding the first user into a participant list, there is further comprised:
constructing a user set based on the first user, the third user and each user in the participant list, the user set comprising N users; and
adding the third user into the participant list in response to any of: a variance of association relationship between each user and remaining users in the user set is minimal, and a sum of connectivity between each user and remaining users in the user set is maximal.

37. The method of claim 32, further comprising:
in response to the contact information comprising a plurality of address books, obtaining a mapping relationship between one of the plurality of other users and contacts in the plurality of address books based on a cross link algorithm.

38. An apparatus for transmitting information, comprising:
a creating module configured to create an activity in response to having received inputted information from a first user;
a lookup module configured to look up a first number of users matching the activity in contact information of the first user ;
an adding module configured to add the first number of users into a candidate list; and
a transmitting module configured to transmit a notification of the activity to users in the candidate list;
wherein the contact information comprises at least one address book through which the first user communicates with a plurality of other users via at least one communication channel.

39. The apparatus of claim 38, further comprising:
a second lookup module configured to, in at least one round, look up a second number of users matching the activity in contact information of a second user in the candidate list;
a second adding module configured to add the second number of users into the candidate list; and
a second transmitting module configured to transmit the notification to the second number of users.

40. The apparatus of claim 38, wherein the lookup module comprises:
a closeness calculating module configured to calculate closeness between the first user and a user among the plurality of other users; and
a selecting module configured to select the first number of users with the highest closeness from the plurality of other users.

41. The apparatus of claim 40, wherein the closeness calculating module comprises:
a weight obtaining module configured to, with respect to a user Uᵢ. among the plurality of other users, obtain a weight Wⱼ of each communication channel Cⱼ in the at least one communication channel;
a frequency obtaining module configured to obtain frequency Rⱼⁱ that the first user communicates with the user Uᵢ. via the communication channel Cⱼ; and
a calculating module configured to calculate closeness CRᵢ=ΣWⱼ·Rⱼⁱ between the first user and the user Uᵢ.

42. The apparatus of claim 41, wherein the frequency Rⱼⁱ is calculated based on the ratio of communications between the first user and the user Uᵢ. via the communication channel Cⱼ to total communications between the first user and the user Uᵢ.

43. The apparatus of claim 38, further comprising:
a receiving module configured to receive feedback from users in the candidate list, types of the feedback at least comprising “participating;”
a participant adding module configured to, in response to the type of feedback from a third user in the candidate list being “participating,” add the third user into a participant list; and
a presenting module configured to present the participant list to the first user.

44. The apparatus of claim 43, further comprising:
a constructing module configured to construct a user set based on the first user, the third user and each user in the participant list, the user set consisting of N users; and
a filtering module configured to add the third user into the participant list in response to any of: a variance of association relationship between each user and remaining users in the user set is minimal, and a sum of connectivity between each user and remaining users in the user set is maximal.

45. The apparatus of claim 38, further comprising:
an obtaining module configured to, in response to the contact information comprising a plurality of address books, obtain a mapping relationship between one of the plurality of other users and contacts in the plurality of address books based on a cross link algorithm.

46. An apparatus for transmitting information, comprising:
at least one processor and at least one memory comprising computer program code, wherein the at least one memory and the computer program code are configured to use the at least one processor to cause the apparatus to:
create an activity in response to having received inputted information from a first user ;
look up a first number of users matching the activity in contact information of the first user;
add the first number of users into a candidate list; and
transmit a notification of the activity to users in the candidate list;
wherein the contact information comprises at least one address book through which the first user communicates with a plurality of other users via at least one communication channel.

47. The apparatus of claim 46, wherein the at least one memory and the computer program code are further configured to use the at least one processor to cause the apparatus to: in at least one round,
look up a second number of users matching the activity in contact information of a second user in the candidate list;
add the second number of users into the candidate list; and
transmit the notification to the second number of users.

48. The apparatus of claim 46, wherein the at least one memory and the computer program code are further configured to use the at least one processor to cause the apparatus to:
calculate closeness between the first user and a user among the plurality of other users; and
select a first number of users with the highest closeness from the plurality of other users.

49. The apparatus of claim 46, wherein the at least one memory and the computer program code are further configured to use the at least one processor to cause the apparatus to:
receive feedback from users in the candidate list, types of the feedback at least comprising “participating;”
in response to the type of feedback from a third user in the candidate list being “participating,” add the third user into a participant list; and
present the participant list to the first user.

50. The apparatus of claim 49, wherein the at least one memory and the computer program code are further configured to use the at least one processor to cause the apparatus to:
construct a user set based on the first user, the third user and each user in the participant list, the user set comprising N users; and
add the third user into the participant list in response to any of: a variance of association relationship between each user and remaining users in the user set is minimal, and a sum of connectivity between each user and remaining users in the user set is maximal.

51. The apparatus of claim 46, wherein the at least one memory and the computer program code are further configured to use the at least one processor to cause the apparatus to:
in response to the contact information comprising a plurality of address books, obtain a mapping relationship between one of the plurality of other users and contacts in the plurality of address books based on a cross link algorithm.
